(19) United States
(12) Patent Application Publication
(10) Pub. No.: US 2024/0155406 A1
(43) Pub. Date: May 9, 2024

(54) CHANNEL STATE INFORMATION REPORT ENHANCEMENTS

(71) Applicant: ZTE Corporation, Shenzhen (CN)

(72) Inventors: Minqiang ZOU, Shenzhen (CN); Shujuan ZHANG, Shenzhen (CN); Bo GAO, Shenzhen (CN); Zhaohua LU, Shenzhen (CN)

(21) Appl. No.: 18/530,751

(22) Filed: Dec. 6, 2023

Related U.S. Application Data
(63) Continuation of application No. PCT/CN2022/111557, filed on Aug. 10, 2022.

(51) Int. Cl. H04W 24/10

(52) U.S. Cl. CPC H04W 24/10

(57) ABSTRACT

An example method includes performing a plurality of measurements relating to a channel status; determining a plurality of bases according to the plurality of measurements, with each basis corresponding to one of a plurality of domains; and transmitting a report that includes information about the plurality of bases to a wireless communication node. The information identifies the plurality of bases and indicates coefficients on the plurality of bases from which the plurality of measurements can be decoded.

### CROSS REFERENCE TO RELATED APPLICATIONS

This patent document is a continuation of and claims benefit of priority to International Patent Application No. PCT/CN2022/111557, filed on Aug. 10, 2022. The entire content of the before-mentioned patent application is incorporated by reference as part of the disclosure of this application.

### TECHNICAL FIELD

This document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for enhancing channel state information (CSI) measurement and reporting. Embodiments disclosed herein provide technical improvements over existing technologies in which CSI communications have significant overhead. Existing CSI communications cause significant performance losses in high-speed applications. These and other technical challenges are addressed.

In an exemplary aspect, a method for wireless communication is disclosed. The method includes performing a plurality of measurements. The method further includes determining a plurality of bases according to the plurality of measurements. Each basis corresponds to one of a plurality of domains. The method further includes transmitting, to a wireless communication node, a report that includes information about the plurality of bases.

In some embodiments, the information about the plurality of bases includes a plurality of information portions, and each information portion is associated with a corresponding domain of the plurality of domains. In some embodiments, a number of the plurality of information portions is equal to a number of the plurality of domains. In some embodiments, each information portion identifies, from a base set for the corresponding domain, each basis of the plurality of bases that corresponds to the corresponding domain.

In some embodiments, the information about the plurality of bases includes a plurality of information portions, and each information portion is associated with one or more corresponding domains of the plurality of domains. In some embodiments, a number of the plurality of information portions is less than a number of the plurality of domains, and at least one of the information portions is associated with a pair of domains of the plurality of domains. In some embodiments, each information portion identifies, from respective base sets for the one or more corresponding domains, each basis of the plurality of bases that corresponds to the one or more corresponding domains.

In some embodiments, the information included in the report is configured to indicate the plurality of bases relative to a particular basis that is selected as a reference basis.

In some embodiments, the information included in the report includes one or more bitmaps each including a plurality of bits that each correspond to two or more bases of the plurality of bases, and wherein the two or more bases correspond to different domains. In some embodiments, a zero bit of the one or more bitmaps identifies weighted coefficients corresponding to each of the two or more bases that is not included in the report. In some embodiments, a total number of nonzero bits across the one or more bitmaps is less than or equal to a threshold that is based on a higher-layer parameter. In some embodiments, a number of nonzero bits in a bitmap of the one or more bitmaps is less than or equal to a threshold that is based on a higher-layer parameter.

In some embodiments, the plurality of bases is determined in response to a higher-layer parameter of a radio resource control (RRC) signaling received by the wireless communication device having a particular value. In some embodiments, the higher-layer parameter is TimedomaincorrelationMode, and wherein the particular value of 1.

In some embodiments, each of the plurality of bases is a discrete Fourier transform (DFT) basis.

In some embodiments, the report relates to a channel status of a channel. In some embodiments, each of the plurality of measurements corresponds to a different measurement time occasion of a channel state information reference signal (CSI-RS) resource. In some embodiments, each of the plurality of measurements corresponds to a measurement time occasion of a different CSI-RS resource.

In some embodiments, the method further includes selecting the plurality of bases from respective base sets for the plurality of domains. In some embodiments, a number of the plurality of bases that is selected in each of the plurality of domains is indicated in a RRC signaling received by the wireless communication device.

In another exemplary aspect, a method for wireless communication is disclosed. The method includes transmitting, to a wireless communication device, a reference signal. The method further includes receiving, from the wireless communication device, a report that includes information about a plurality of bases that are determined based on the reference signal. Each basis corresponds to one of a plurality of domains. The method further includes decoding the information about the plurality of bases.

In some embodiments, the method further includes determining, for each of the plurality of domains, a parameter that indicates a number of bases to be included in the report. In some embodiments, the method further includes transmitting, to the wireless communication device, a RRC signaling that includes the parameter for each of the plurality of domains. In some embodiments, the RRC signaling includes a TimedomaincorrelationMode parameter.

In some embodiments, the reference signal includes a channel state information reference signal (CSI-RS) that is transmitted via a radio channel and configured to enable a plurality of measurements relating to the channel status for the radio channel.

In some embodiments, the method further includes obtaining a second information about the plurality of measurements based on the decoding of the information about the plurality of bases. The plurality of measurements are performed by the wireless communication device. In some embodiments, each of the plurality of measurements corresponds to a different measurement time occasion of a reference signal resource of the reference signal. In some embodiments, each of the plurality of measurements corresponds to a measurement time occasion of a different reference signal resource of the reference signal.

In some embodiments, the information about the plurality of bases includes a plurality of information portions, and each information portion is associated with a corresponding domain of the plurality of domains. In some embodiments, a number of the plurality of information portions is equal to a number of the plurality of domains. In some embodiments, each information portion identifies, from a base set for the corresponding domain, each basis of the plurality of bases that corresponds to the corresponding domain.

In some embodiments, the information about the plurality of bases includes a plurality of information portions, and wherein each information portion is associated with one or more corresponding domains of the plurality of domains. In some embodiments, a number of the plurality of information portions is less than a number of the plurality of domains, and at least one of the information portions is associated with a pair of domains of the plurality of domains. In some embodiments, each information portion identifies, from respective base sets for the one or more corresponding domains, each basis of the plurality of bases that corresponds to the one or more corresponding domains.

In some embodiments, the information included in the report is configured to indicate the plurality of bases relative to a particular basis that is selected as a reference basis. In some embodiments, the reference basis is a discrete Fourier transform vector numbered zero in the domain.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWINGS

FIG. 1 shows an exemplary flowchart for a method of wireless communication for enhancing CSI measurement and reporting.

FIG. 2 shows an exemplary flowchart for a method of wireless communication for enhancing CSI measurement and reporting.

FIG. 3 shows an exemplary block diagram of a hardware platform that may be a part of a network device or a communication device.

FIG. 4 shows an example of wireless communication including a base station (BS) and user equipment (UE) based on some implementations of the disclosed technology.

FIG. 5 is a tabular presentation of values of indicated combinatorial coefficients.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Overview

In 3rd Generation Partnership Project (3GPP) Release 18 (Rel-18), significant loss of performance for a user equipment (UE) traveling at a high/medium speed (e.g., greater than 10 km/h, greater than 15 km/h, greater than 20 km/h) has been observed in commercial deployments, especially in multi-user multiple-input multiple-output (MU-MIMO) scenarios. This significant performance loss is partly caused by outdated channel state information (CSI) communications. For example, these outdated CSI communications include overhead that cause delays in time between when a CSI communication (e.g., a CSI reporting signal) is transmitted by a device and when the CSI communication is received by another device. Further, example CSI communications such as CSI reports are specific to certain points in time, and delays in communicating a CSI report results in the CSI report being irrelevant if a channel state has changed in that time.

Accordingly, a need for enhancements on CSI measurement and reporting exists to alleviate significant performance loss. Embodiments described herein exploit time-domain correlation/Doppler-domain information to assist precoding for alleviating performance loss and reducing CSI overhead due to rapid aging of the reported CSI. Some embodiments are based on Rel-16/17 Type-II codebook refinement. For example, in some embodiments, a CSI report indicates channel state information corresponding to multiple measurement intervals. The time-spanning channel state information is indicated in the CSI report in an efficient manner through the exploitation of time-domain correlation/Doppler-domain information. As such, embodiments described herein provide technical benefits and improvements that improve performance for UEs, and especially for UEs travelling at high speeds. Embodiments described herein introduce example codebook structures, base vectors design of precoding, non-zero coefficient designs, higher-layer parameters, and the like.

### II. Example Embodiment 1

Multiple-input multiple-output (MIMO) is one of the key technologies in new radio (NR) systems and is successful in commercial deployment. In 3GPP Rel-15/16/17, MIMO features were investigated and specified for both frequency division duplex (FDD) and time division duplex (TDD) systems.

For Rel-16/17 Type-II codebooks (CBs), the precoding matrix, per layer, and across all subbands configured for reporting, follows the codebook structure:

W=W₁W₂W_{f}^{H} (1)

In Equation 1, W₁ is a matrix of wideband DFT beams, of size 2N₁N₂*2N and is formed by the same N orthogonal beams or ports for each of the two polarizations, selected from a set of oversampled 2D DFT beams or from P_{CSI-RS}/2 ports. N₁ and N₂ are the number of antenna ports in horizontal and vertical dimensions of the transmit rectangular array and P_{CSI-RS} is the number of CSI-RS ports in the port selection CB. W_{f} is a matrix of frequency domain (FD) basis components of size N₃×M. N₃ is the number of precoding matric indicator (PMI) subbands, and N₃ is formed by M orthogonal vectors that are selected from a discrete Fourier transform (DFT) codebook. W₂ is a 2N*M matrix containing combination coefficients for each pair of SD and FD basis components.

Accordingly, for Rel-16 Type-II codebook, the precoding matrix, per layer, and across all subbands follows the codebook structure of Equation 1, in which W₁ represents a matrix of SD bases, W_{f} is a matrix of FD bases, and W₂ is a matrix containing combination coefficients for SD and FD basis components.

Considering a UE calculating N4 precoding matrix indicators (PMIs):

If W₁ and W_{f} are independent between the N4 PMIs:

$${W}^{( {t}_{1} )} = {W}_{1}^{( {t}_{1} )} {{W}_{2}^{( {t}_{1} )} ( {W}_{f}^{H} )}^{( {t}_{1} )}$$

$${W}^{( {t}_{2} )} = {W}_{1}^{( {t}_{2} )} {{W}_{2}^{( {t}_{2} )} ( {W}_{f}^{H} )}^{( {t}_{2} )}$$

$$⋮$$

$${W}^{( {t}_{N 4} )} = {W}_{1}^{( {t}_{N 4} )} {{W}_{2}^{( {t}_{N 4} )} ( {W}_{f}^{H} )}^{( {t}_{N 4} )}$$

If W₁ and W_{f} are common between the N4 PMIs:

$${W}^{( {t}_{1} )} = {W}_{1} {{W}_{2}}^{( {t}_{1} )} ( {W}_{f}^{H} )$$

$${W}^{( {t}_{2} )} = {W}_{1} {{W}_{2}}^{( {t}_{2} )} ( {W}_{f}^{H} )$$

$$⋮$$

$${W}^{( {t}_{N 4} )} = {W}_{1} {{W}_{2}}^{( {t}_{N 4} )} ( {W}_{f}^{H} )$$

In some embodiments, a parameter TimedomaincorrelationMode is configured by higher layer. In some embodiments, the parameter TimedomaincorrelationMode controls backward compatibility with Rel-16 Type-II codebook structures.

For example, if TimedomaincorrelationMode=0, a single W₁ and W_{f} are mapped to N4 W₂, and time-domain correlation or Doppler-domain information are not considered. If TimedomaincorrelationMode=1, time-domain correlation and Doppler-domain information are considered as the UE configures a reporting signal according to a codebook structure that is different from Rel-16 Type-II codebook structures. In particular, in some embodiments, the different codebook structure enables CSI reporting information for multiple measurement time intervals or points in time to be efficiently represented without significant overhead.

On condition of common W₁ and W_{f} and consideration of time-domain correlation/Doppler-domain information, there are four codebook structures (described as four cases in each of the following example embodiments) that enable a UE to compress PMI information between the N4 PMIs. In this case, the position of nonzero coefficient between the N4 PMIs are different.

On condition of common W₁ and W_{f} and consideration of time-domain correlation/Doppler-domain information, there are four codebook structures (described as four cases in each of the following example embodiments) that enable a UE to compress PMI information between the N4 PMIs. In this case, the position of nonzero coefficient between the N4 PMIs are same.

### III. Example Embodiment 2

### Case 1: (Non-Pair)

### Selecting SD Basis, FD Basis, and DD Basis

In some embodiments, a UE reports three independent parameters for selecting spatial domain (SD) basis, frequency domain (FD) basis, and Doppler domain (DD) basis. The three independent parameters are individual parameters to indicate SD basis, FD basis and DD basis (e.g., the selection thereof).

In some embodiments, N, M, and K represent the number of selected SD basis, FD basis, and DD basis, respectively. In some embodiments, N, M, and K are configured by a wireless communication node, such as a base station or gNodeB (gNB). In some embodiments, N, M, and K are indicated to a UE by a base station during a radio resource control (RRC) signaling, and the UE selects a number of SD bases, FD bases, and DD bases according to N, M, and K, respectively.

In some embodiments, the selected basis/bases are indicated by bitmaps or combinatorial coefficients.

In some embodiments, the selected N number of SD basis/bases are indicated by bitmaps. The bitmap indicating the selected N number of SD basis/bases occupies N₁*N₂ bits. The values of N₁ and N₂ are configured with the higher layer parameter n1−n2, which means the number of CSI-RS ports in horizontal and vertical dimensions.

In some embodiments, the selected N number of SD basis/bases are indicated by combinatorial coefficients. The combinatorial coefficient indicating the selected N number of SD basis/bases occupies

$$⌈ {log}_{2} ( \begin{matrix}{N}_{1} {N}_{2} \\ N\end{matrix} ) ⌉$$

bits.

In some embodiments, the selected M number of FD basis/bases are indicated by bitmaps. The bitmap indicating the selected M number of FD basis/bases occupies N₃ bits. The value of N₃ is the number of total number of FD precoding matrices, which is controlled by the higher-layer parameter numberOfPMI-SubbandsPerCQI-Subband.

For example: N3=numberOfPMI-SubbandsPerCQI-Subband*subband number.

In some embodiments, the selected M number of FD basis/bases are indicated by combinatorial coefficients. The combinatorial coefficient indicating the selected M number of FD basis/bases occupies

$$⌈ {log}_{2} ( \begin{matrix}{N}_{3} \\ M\end{matrix} ) ⌉$$

bits.

In some embodiments, the selected K number of DD basis/bases are indicated by bitmaps. The bitmap indicating the selected K number of DD basis/bases occupies N_{T} bits. The value of N_{T} is the number of total number of DD precoding matrices, which is controlled by the CSI measurement window.

In some embodiments, the selected K number of DD basis/bases are indicated by combinatorial coefficients. The combinatorial coefficient indicating the selected K number of DD basis/bases occupies

$$⌈ {log}_{2} ( \begin{matrix}{N}_{T} \\ K\end{matrix} ) ⌉$$

bits.

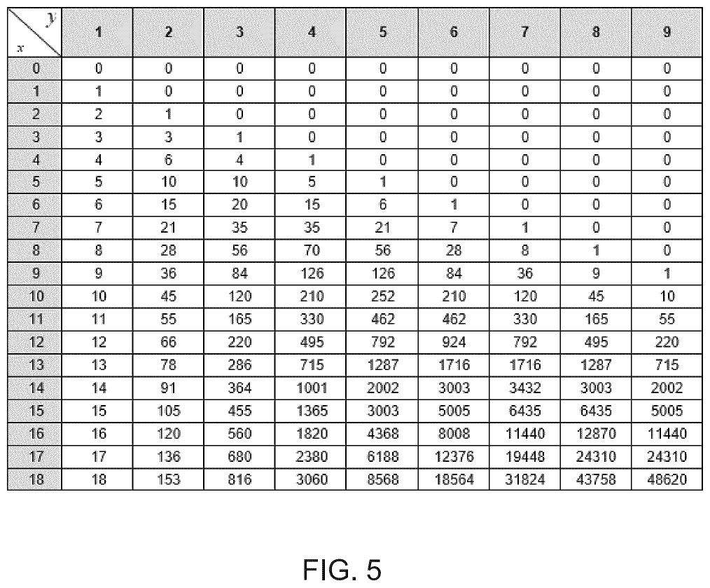

In some embodiments, the values of indicated combinatorial coefficients for selecting SD, FD or DD basis in above are given in Table 1 and FIG. 5.

TABLE 1
Combinatorial coefficients C(x, y)

| | y | | | | | | | | |
|---|---|---|---|---|---|---|---|---|---|
| x | 1 | 2 | 3 | 4 | 5 | 6 | 7 | 8 | 9 |
| 0 | 0 | 0 | 0 | 0 | 0 | 0 | 0 | 0 | 0 |
| 1 | 1 | 0 | 0 | 0 | 0 | 0 | 0 | 0 | 0 |
| 2 | 2 | 1 | 0 | 0 | 0 | 0 | 0 | 0 | 0 |
| 3 | 3 | 3 | 1 | 0 | 0 | 0 | 0 | 0 | 0 |
| 4 | 4 | 6 | 4 | 1 | 0 | 0 | 0 | 0 | 0 |
| 5 | 5 | 10 | 10 | 5 | 1 | 0 | 0 | 0 | 0 |
| 6 | 6 | 15 | 20 | 15 | 6 | 1 | 0 | 0 | 0 |
| 7 | 7 | 21 | 35 | 35 | 21 | 7 | 1 | 0 | 0 |
| 8 | 8 | 28 | 56 | 70 | 56 | 28 | 8 | 1 | 0 |
| 9 | 9 | 36 | 84 | 126 | 126 | 84 | 36 | 9 | 1 |
| 10 | 10 | 45 | 120 | 210 | 252 | 210 | 120 | 45 | 10 |
| 11 | 11 | 55 | 165 | 330 | 462 | 462 | 330 | 165 | 55 |
| 12 | 12 | 66 | 220 | 495 | 792 | 924 | 792 | 495 | 220 |
| 13 | 13 | 78 | 286 | 715 | 1287 | 1716 | 1716 | 1287 | 715 |
| 14 | 14 | 91 | 364 | 1001 | 2002 | 3003 | 3432 | 3003 | 2002 |
| 15 | 15 | 105 | 455 | 1365 | 3003 | 5005 | 6435 | 6435 | 5005 |
| 16 | 16 | 120 | 560 | 1820 | 4368 | 8008 | 11440 | 12870 | 11440 |
| 17 | 17 | 136 | 680 | 2380 | 6188 | 12376 | 19448 | 24310 | 24310 |
| 18 | 18 | 153 | 816 | 3060 | 8568 | 18564 | 31824 | 43758 | 48620 |

### Nonzero Coefficient Design

In some embodiments, a total number of non-zero coefficients is limited. The total number of non-zero coefficients K_{NZ} is controlled by K₀, where K₀=┌β·2NMK┐, 0<β≤1. In some embodiments, the values of β are determined by a higher layer parameter.

If rank=1, then K_{NZ}≤K₀.

If rank>1, then K_{NZ}≤C*K₀, where C is a constant. For example, C=2, 3, 4, or the like.

In some embodiments, the individual number of non-zero coefficients in SD basis, FD basis, and DD basis are limited.

For SD basis, the number of nonzero coefficients K_{NZ-SD} is less than or equal to K_{0-SD}=┌β_{SD}·2N┐, 0<β_{SD}≤1.

For FD basis, the number of nonzero coefficients K_{NZ-FD} is less than or equal to K_{0-FD}=┌β_{FD}·M┐, 0<β_{FD}≤1.

For DD basis, the number of nonzero coefficients K_{NZ-DD} is less than or equal to K_{0-FD}=┌β_{FD}·K┐, 0<β_{DD}≤1.

In some embodiments, the three values for β (e.g., β_{SD}, β_{FD}, β_{DD}) are determined by higher layer parameters.

### Case 2: (SD-FD Pair)

### Selecting SD Basis, FD Basis, and DD Basis

In some embodiments, a UE reports two independent parameters for selecting SD basis, FD basis, and DD basis. A parameter is used to indicate the pair of SD basis and FD basis. Another parameter is used to indicate DD basis.

In some embodiments, N and M are not used due to the pairing of SD bases and FD bases. In some embodiments, a P parameter, determined by a higher layer parameter, is the number of SD-FD pairs. In some embodiments, P and K are configured by a gNB.

In some embodiments, the selected NM pairs of SD basis and FD basis are indicated by bitmaps. Table 2 provides an example of a bitmap indicated pairs of SD basis and FD basis in an example in which 2N₁*N₂=4, N₃=6, and P=3. In the example of Table 2, the bitmap occupies 24 bits. Empty entries in the example of Table 2 can be interpreted as having a value of 0.

TABLE 2
Example bitmap for indicating selected SD-FD pairs

| | SD-1 | SD-2 | SD-3 | SD-4 |
|---|---|---|---|---|
| FD-1 | | | | |
| FD-2 | | | 1 | |
| FD-3 | | | | |
| FD-4 | | 1 | | |
| FD-5 | | 1 | | |
| FD-6 | | | | |

In some embodiments, the bitmap indicating selected P pairs of SD basis and FD basis occupies 2N₁N₂*N₃ bits.

In some embodiments, the selected P pairs of SD basis and FD basis are indicated by combinatorial coefficients. The combinatorial coefficient indicating selected NM pairs of SD basis and FD basis occupies

$$⌈ {log}_{2} ( \begin{matrix}2 {N}_{1} {N}_{2} {N}_{3} \\ P\end{matrix} ) ⌉$$

bits.

In some embodiments, the selected K number of DD basis/bases are indicated by bitmaps. The bitmap indicating the selected K number of DD basis/bases occupies N_{T} bits. The value of N_{T} is the number of total number of DD precoding matrices, which is controlled by the CSI measurement window.

In some embodiments, the selected K number of DD basis/bases are indicated by combinatorial coefficients. The combinatorial coefficient indicating the selected K number of DD basis/bases occupies

$$⌈ {log}_{2} ( \begin{matrix}{N}_{T} \\ K\end{matrix} ) ⌉$$

bits.

In some embodiments, the values of indicated combinatorial coefficients for selecting SD-FD basis pair or DD basis in above are given in Table 1.

### Nonzero Coefficient Design

In some embodiments, the nonzero coefficients for SD-FD basis pairs and DD bases are indicated in one bitmap or combinatorial coefficients. In some embodiments, one bitmap or one set of combinatorial coefficients are used to indicate the position of nonzero coefficients for SD-FD basis pairs and DD bases, and one parameter is used to indicate the number of nonzero coefficients. For example, the bitmap length is P*K.

In some embodiments, a total number of non-zero coefficients is limited. The total number of non-zero coefficients K_{NZ} is controlled by K₀.

If rank=1, then K_{NZ}≤K₀.

If rank>1, then K_{NZ}≤C*K₀, where C is a constant. For example, C=2, 3, 4, or the like.

For DD basis, the number of nonzero coefficients K_{NZ-DD} is less than or equal to K_{0-DD}=┌β_{DD}·K┐, 0<β_{DD}≤1, and β_{DD} is determined by higher layer parameters, in some embodiments.

### Case 3: (FD-DD Pair)

### Selecting SD Basis, FD Basis, and DD Basis

In some embodiments, a UE reports two independent parameters for selecting SD basis, FD basis, and DD basis. A parameter is used to indicate the pair of FD basis and DD basis. Another parameter is used to indicate SD basis.

In some embodiments, M and K are not used due to the pairing of FD bases and DD bases. In some embodiments, a P parameter, determined by a higher layer parameter, is the number of FD-DD pairs. In some embodiments, N and P are configured by a gNB.

In some embodiments, the selected P pairs of FD basis and DD basis are indicated by bitmaps.

In some embodiments, the selected P pairs of FD basis and DD basis are indicated by combinatorial coefficients.

In some embodiments, the selected N number of SD basis/bases are indicated by bitmaps.

In some embodiments, the selected N number of SD basis/bases are indicated by combinatorial coefficients.

### Nonzero Coefficient Design

In some embodiments, the nonzero coefficients for FD-DD basis pairs and SD bases are indicated in one bitmap or combinatorial coefficients. In some embodiments, one bitmap or one set of combinatorial coefficients are used to indicate the position of nonzero coefficients for FD-DD basis pairs and SD bases, and one parameter is used to indicate the number of nonzero coefficients. For example, the bitmap length is P*N.

In some embodiments, a total number of non-zero coefficients is limited. The total number of non-zero coefficients K_{NZ} is controlled by K₀.

If rank=1, then K_{NZ}≤K₀.

If rank>1, then K_{NZ}≤C*K₀, where C is a constant. For example, C=2, 3, 4, or the like.

For SD basis, the number of nonzero coefficients K_{NZ-DD} is less than or equal to K_{0-SD}=┌β_{SD}·2N┐, 0<β_{SD}≤1, and β_{SD} is determined by higher layer parameters, in some embodiments.

### Case 4: (SD-DD Pair)

### Selecting SD Basis, FD Basis, and DD Basis

In some embodiments, a UE reports two independent parameters for selecting SD basis, FD basis, and DD basis. A parameter is used to indicate the pair of SD basis and DD basis. Another parameter is used to indicate FD basis.

In some embodiments, N and K are not used due to the pairing of SD bases and DD bases. In some embodiments, a P parameter, determined by a higher layer parameter, is the number of SD-DD pairs. In some embodiments, M and P are configured by a gNB.

In some embodiments, the selected P pairs of SD basis and DD basis are indicated by bitmaps.

In some embodiments, the selected P pairs of SD basis and DD basis are indicated by combinatorial coefficients.

In some embodiments, the selected M number of FD basis/bases are indicated by bitmaps.

In some embodiments, the selected M number of FD basis/bases are indicated by combinatorial coefficients.

### Nonzero Coefficient Design

In some embodiments, the nonzero coefficients for SD-DD basis pairs and FD bases are indicated in one bitmap or combinatorial coefficients. In some embodiments, one bitmap or one set of combinatorial coefficients are used to indicate the position of nonzero coefficients for SD-DD basis pairs and FD bases, and one parameter is used to indicate the number of nonzero coefficients. For example, the bitmap length is P*M.

In some embodiments, a total number of non-zero coefficients is limited. The total number of non-zero coefficients K_{NZ} is controlled by K₀.

If rank=1, then K_{NZ}≤K₀.

If rank>1, then K_{NZ}≤C*K₀, where C is a constant. For example, C=2, 3, 4, or the like.

For SD basis, the number of nonzero coefficients K_{NZ-DD} is less than or equal to K_{0-FD}=┌β_{FD}·M┐, 0<β_{FD}≤1, and β_{FD} is determined by higher layer parameters, in some embodiments.

### IV. Example Embodiment 3

In some embodiments, a reference basis in the FD and the DD is used to reduce further overhead of CSI reporting. For the selected M DFT FD bases and K DFT DD bases, the absolute value for FD and DD basis does not affect the performance of precoding. Instead, the relative value for FD and DD basis affects the performance of precoding, due to the properties of orthogonal DFT vectors. Using a reference FD basis and a reference DD basis, relative values for selected FD bases and selected DD bases are accurately represented.

In some embodiment, for reducing overhead, a DFT vector numbered 0 in DFT matrix is selected as the reference basis. The UE only needs to report the number information of the remaining M−1 or K−1 DFT vectors after cyclic shift. As such, embodiments described in this section provide technical improvements with additional overhead reductions and performance enhancements for channel state information measurement and reporting.

### Case 1 (Non-Pair)

### Selecting SD Basis, FD Basis, and DD Basis

In some embodiments, a UE reports three independent parameters for selecting spatial domain (SD) basis, frequency domain (FD) basis, and Doppler domain (DD) basis. The three independent parameters are individual parameters to indicate SD basis, FD basis and DD basis (e.g., the selection thereof).

In some embodiments, N, M−1, and K−1 represent the number of selected SD basis, FD basis, and DD basis, respectively. In some embodiments, N, M, and K are configured by a wireless communication node, such as a base station or gNodeB (gNB). In some embodiments, N, M, and K are indicated to a UE by a base station during a radio resource control (RRC) signaling, and the UE selects a number of SD bases, FD bases, and DD bases according to N, M, and K, respectively.

In some embodiments, the selected basis/bases are indicated by bitmaps or combinatorial coefficients.

In some embodiments, the selected N number of SD basis/bases are indicated by bitmaps. The bitmap indicating the selected N number of SD basis/bases occupies N₁*N₂ bits. The values of N₁ and N₂ are configured with the higher layer parameter n1−n2, which means the number of CSI-RS ports in horizontal and vertical dimensions.

In some embodiments, the selected N number of SD basis/bases are indicated by

combinatorial coefficients. The combinatorial coefficient indicating the selected N number of SD basis/bases occupies

$$⌈ {log}_{2} ( \begin{matrix}{N}_{1} {N}_{2} \\ N\end{matrix} ) ⌉$$

bits.

In some embodiments, the selected M−1 number of FD basis/bases are indicated by bitmaps. The bitmap indicating the selected M number of FD basis/bases occupies N₃−1 bits. The value of N₃ is the number of total number of FD precoding matrices, which is controlled by the higher-layer parameter numberOfPMI-SubbandsPerCQI-Subband.

For example: N3=numberOfPMI-SubbandsPerCQI-Subband*subband number.

In some embodiments, the selected M−1 number of FD basis/bases are indicated by combinatorial coefficients. The combinatorial coefficient indicating the selected M−1 number of FD basis/bases occupies

$$⌈ {log}_{2} ( \begin{matrix}{N}_{3} - 1 \\ M - 1\end{matrix} ) ⌉$$

bits.

In some embodiments, the selected K−1 number of DD basis/bases are indicated by bitmaps. The bitmap indicating the selected K number of DD basis/bases occupies N_{T}−1 bits. The value of N_{T} is the number of total number of DD precoding matrices, which is controlled by the CSI measurement window.

In some embodiments, the selected K−1 number of DD basis/bases are indicated by combinatorial coefficients. The combinatorial coefficient indicating the selected K−1 number of DD basis/bases occupies

$$⌈ {log}_{2} ( \begin{matrix}{N}_{T} - 1 \\ K - 1\end{matrix} ) ⌉$$

bits.

In some embodiments, the values of indicated combinatorial coefficients for selecting SD, FD or DD basis in above are given in Table 1.

### Nonzero Coefficient Design

In some embodiments, a total number of non-zero coefficients is limited. The total number of non-zero coefficients K_{NZ} is controlled by K₀, where K₀=┌β·2NMK┐, 0<β≤1. In some embodiments, the values of β are determined by a higher layer parameter.

If rank=1, then K_{NZ}≤K₀.

If rank>1, then K_{NZ}≤C*K₀, where C is a constant. For example, C=2, 3, 4, or the like.

In some embodiments, the individual number of non-zero coefficients in SD basis, FD basis, and DD basis are limited.

For SD basis, the number of nonzero coefficients K_{NZ-SD} is less than or equal to K_{0-SD}=┌β_{SD}·2N┐, 0<β_{SD}≤1.

For FD basis, the number of nonzero coefficients K_{NZ-FD} is less than or equal to K_{0-FD}=┌β_{FD}·M┐, 0<β_{FD}≤1.

For DD basis, the number of nonzero coefficients K_{NZ-DD} is less than or equal to K_{0-FD}=┌β_{FD}·K┐, 0<β_{DD}≤1.

In some embodiments, the three values for β (e.g., β_{SD}, β_{FD}, β_{DD}) are determined by higher layer parameters.

### Case 2: (SD-FD Pair)

### Selecting SD Basis, FD Basis, and DD Basis

In some embodiments, a UE reports two independent parameters for selecting SD basis, FD basis, and DD basis. A parameter is used to indicate the pair of SD basis and FD basis. Another parameter is used to indicate DD basis.

In some embodiments, N, M−1, and K−1 are the number of selected SD basis, FD basis, and DD basis, respectively. In some embodiments, N, M, and K are configured by a gNB.

In some embodiments, the number of pairs of SD basis and FD basis is N*(M−1). In some embodiments, the number of pairs of SD basis and FD basis is P, and N and M are not used. In some embodiments, (P−1) is based on (e.g., is equal to) N*(M−1). Due to the use of a reference FD basis, the value of P is reduced.

In some embodiments, the selected (P−1) pairs of SD basis and FD basis are indicated by bitmaps. Table 3 provides an example of a bitmap indicated pairs of SD basis and FD basis in an example in which (P−1)=2. In the example of Table 3, the bitmap occupies 20 bits.

As shown, the bitmap represented by Table 3 that implements a reference FD basis (indicated by *) reduces further overhead in comparison to the bitmap represented by Table 2. In particular, FD−1 is selected as a reference FD basis. In the illustrated example, the bitmap indication of Table 2 that included three 1 values (shown in strikethrough in Table 3) can be reduced, due to the reference FD basis, to just two 1 values (shown in brackets).

TABLE 3
Example bitmap for indicating selected
SD-FD pairs with reference FD basis

| | SD-1 | SD-2 | SD-3 | SD-4 |
|---|---|---|---|---|
| FD-1(*) | | | | |
| FD-2 | | | [symbol] | |
| FD-3 | | [1] | | |
| FD-4 | | [symbol] [1] | | |
| FD-5 | | [symbol] | | |
| FD-6 | | | | |

In some embodiments, the bitmap indicating selected N*(M−1) or P pairs of SD basis and FD basis occupies N₁N₂N₃ bits.

In some embodiments, the selected N*(M−1) or P pairs of SD basis and FD basis are indicated by combinatorial coefficients. The combinatorial coefficient indicating selected pairs of SD basis and FD basis occupies

$$⌈ {log}_{2} ( \begin{matrix}{N}_{1} {N}_{2} {N}_{3} \\ max ( N , M - 1\end{matrix} ) ⌉$$

bits.

In some embodiments, the selected K−1 number of DD basis/bases are indicated by bitmaps. The bitmap indicating the selected K−1 number of DD basis/bases occupies N_{T}−1 bits. The value of N_{T} is the number of total number of DD precoding matrices, which is controlled by the CSI measurement window.

In some embodiments, the selected K−1 number of DD basis/bases are indicated by combinatorial coefficients. The combinatorial coefficient indicating the selected K number of DD basis/bases occupies

$$⌈ {log}_{2} ( \begin{matrix}{N}_{T} \\ K - 1\end{matrix} ) ⌉$$

bits.

In some embodiments, the values of indicated combinatorial coefficients for selecting SD-FD basis pair or DD basis in above are given in Table 1.

### Nonzero Coefficient Design

In some embodiments, a total number of non-zero coefficients is limited. The total number of non-zero coefficients K_{NZ} is controlled by K₀, where K₀=┌β·2NMK┐, 0<β≤1. In some embodiments, the values of β are determined by a higher layer parameter.

If rank=1, then K_{NZ}≤K₀.

If rank>1, then K_{NZ}≤C*K₀, where C is a constant. For example, C=2, 3, 4, or the like.

In some embodiments, the individual number of non-zero coefficients in SD-FD pair and DD basis are limited.

For SD-FD pair basis, the number of nonzero coefficients K_{NZ-SDFD} is less than or equal to K_{0-SDFD}=┌β_{SDFD}·2N┐, 0<β_{SDFD}≤1.

For DD basis, the number of nonzero coefficients K_{NZ-DD} is less than or equal to K_{0-DD}=┌β_{DD}·2N┐, 0<β_{DD}≤1.

In some embodiments, the two values for β (e.g., β_{SDFD}, β_{DD}) are determined by higher layer parameters.

### Case 3: (FD-DD Pair)

### Selecting SD Basis, FD Basis, and DD Basis

In some embodiments, a UE reports two independent parameters for selecting SD basis, FD basis, and DD basis. A parameter is used to indicate the pair of FD basis and DD basis. Another parameter is used to indicate SD basis.

In some embodiments, N, M−1, and K−1 are the number of selected SD basis, FD basis, and DD basis, respectively. In some embodiments, N, M, and K are configured by a gNB.

In some embodiments, the number of pairs of FD basis and DD basis is (M−1)*(K−1). In some embodiments, the number of pairs of FD basis and DD basis is P, and M and K are not used. In some embodiments, P is based on (M−1)*(K−1). Due to the use of a reference FD basis and a reference DD basis, the value of P is reduced.

In some embodiments, the selected (M−1)*(K−1) or P pairs of FD basis and DD basis are indicated by bitmaps.

In some embodiments, the selected (M−1)*(K−1) or P pairs of FD basis and DD basis are indicated by combinatorial coefficients.

In some embodiments, the selected N number of SD basis/bases are indicated by bitmaps.

In some embodiments, the selected N number of SD basis/bases are indicated by combinatorial coefficients.

### Nonzero Coefficient Design

In some embodiments, a total number of non-zero coefficients is limited. The total number of non-zero coefficients K_{NZ} is controlled by K₀, where K₀=┌β·2NMK┐, 0<β≤1. In some embodiments, the values of β are determined by a higher layer parameter.

If rank=1, then K_{NZ}≤K₀.

If rank>1, then K_{NZ}≤C*K₀, where C is a constant. For example, C=2, 3, 4, or the like.

In some embodiments, the individual number of non-zero coefficients in FD-DD pair and SD basis are limited.

For FD-DD pair basis, the number of nonzero coefficients K_{NZ-FDDD} is less than or equal to K_{0-FDDD}=┌β_{FDDD}·2N┐, 0<β_{FDDD}≤1.

For SD basis, the number of nonzero coefficients K_{NZ-DD} is less than or equal to K_{0-SD}=┌β_{SD}·2N┐, 0<β_{SD}≤1.

In some embodiments, the two values for β (e.g., β_{FDDD}, β_{SD}) are determined by higher layer parameters.

### Case 4: (SD-DD Pair)

### Selecting SD Basis, FD Basis, and DD Basis

In some embodiments, a UE reports two independent parameters for selecting SD basis, FD basis, and DD basis. A parameter is used to indicate the pair of SD basis and DD basis. Another parameter is used to indicate FD basis.

In some embodiments, N, M−1, and K−1 are the number of selected SD basis, FD basis, and DD basis, respectively. In some embodiments, N, M, and K are configured by a gNB.

In some embodiments, the number of pairs of SD basis and DD basis is N*(K−1). In some embodiments, the number of pairs of SD basis and DD basis is P, and N and K are not used. In some embodiments, P is based on N*(K−1). Due to the use of a reference DD basis, the value of P is reduced.

In some embodiments, the selected N*(K−1) or P pairs of SD basis and DD basis are indicated by bitmaps.

In some embodiments, the selected N*(K−1) or P pairs of SD basis and DD basis are indicated by combinatorial coefficients.

In some embodiments, the selected (M−1) number of FD basis/bases are indicated by bitmaps.

In some embodiments, the selected (M−1) number of FD basis/bases are indicated by combinatorial coefficients.

### Nonzero Coefficient Design

In some embodiments, a total number of non-zero coefficients is limited. The total number of non-zero coefficients K_{NZ} is controlled by K₀, where K₀=┌β·2NMK┐, 0<β≤1. In some embodiments, the values of β are determined by a higher layer parameter.

If rank=1, then K_{NZ}≤K₀.

If rank>1, then K_{NZ}≤C*K₀, where C is a constant. For example, C=2, 3, 4, or the like.

In some embodiments, the individual number of non-zero coefficients in FD-DD pair and SD basis are limited.

For SD-DD pair basis, the number of nonzero coefficients K_{NZ-SDDD} is less than or equal to K_{0-SDDD}=┌β_{SDDD}·2N┐, 0<β_{SDDD}≤1.

For SD basis, the number of nonzero coefficients K_{NZ-DD} is less than or equal to K_{0-FD}=┌β_{FD}·2N┐, 0<β_{FD}≤1.

In some embodiments, the two values for β (e.g., β_{FDDD}, β_{SD}) are determined by higher layer parameters.

### V. Example Embodiment 4

To summarize aspects of the disclosure above, embodiments herein disclose selection of SD, FD, and DD bases from SD, FD, and DD base sets, as well as the indication of nonzero coefficients on the selected SD, FD, and DD bases, respectively.

For example, embodiments described herein in the context of Case 1 involve three individual parameters for providing SD basis, FD basis, and DD basis. Generally, in some embodiments, Case 1 includes Step 1 and Step 2.

At Step 1 of Case 1, bases are selected. In some embodiments, N, M, and K are the numbers of selected SD bases, FD bases, and DD bases, respectively. Bitmaps or combinatorial coefficients are used to indicate the selection of SD bases, FD bases, and DD bases from SD, FD, and DD base sets. For example, bitmaps or combinatorial coefficients are used to indicate the selection of SD bases, FD bases, and DD bases from respective base sets.

At Step 2 of Case 1, nonzero coefficients on the selected SD bases, FD bases, and DD bases are indicated in bitmaps or combinatorial coefficients. The following describes four methods by which nonzero coefficients on selected bases are indicated.

### Example Method 1

In some embodiments, the nonzero coefficients on selected SD bases, FD bases, and DD bases are indicated in one bitmap or combinatorial coefficients. One bitmap or combinatorial coefficients are used to indicate the position of nonzero coefficients, and one parameter is used to indicate the number of nonzero coefficients. For example, the bitmap length is 2NMK, which is indicated by a parameter.

### Example Method 2

In some embodiments, the nonzero coefficients on selected SD bases and FD bases are indicated in one bitmap or combinatorial coefficients. One bitmap or combinatorial coefficients are used to indicate the position of nonzero coefficients on selected SD bases and FD bases, and one parameter is used to indicate the number of nonzero coefficients. For example, the bitmap length is 2NM.

Another bitmap or another set of combinatorial coefficients are used to indicate the position of nonzero coefficients on selected DD bases. In some embodiments, the position of nonzero coefficients on selected DD bases are indicated relative to the position of the nonzero coefficients on the selected SD bases and FD bases. One parameter is used to indicate the number of nonzero coefficients on the selected DD bases.

### Example Method 3

In some embodiments, the nonzero coefficients on selected SD bases and DD bases are indicated in one bitmap or combinatorial coefficients. One bitmap or combinatorial coefficients are used to indicate the position of nonzero coefficients on selected SD bases and DD bases, and one parameter is used to indicate the number of nonzero coefficients. For example, the bitmap length is 2NK.

Another bitmap or another set of combinatorial coefficients are used to indicate the position of nonzero coefficients on selected FD bases. In some embodiments, the position of nonzero coefficients on selected FD bases are indicated relative to the position of the nonzero coefficients on the selected SD bases and DD bases. One parameter is used to indicate the number of nonzero coefficients on the selected FD bases.

### Example Method 4

In some embodiments, the nonzero coefficients on selected FD bases and DD bases are indicated in one bitmap or combinatorial coefficients. One bitmap or combinatorial coefficients are used to indicate the position of nonzero coefficients on selected FD bases and DD bases, and one parameter is used to indicate the number of nonzero coefficients. For example, the bitmap length is 2MK.

Another bitmap or another set of combinatorial coefficients are used to indicate the position of nonzero coefficients on selected SD bases. In some embodiments, the position of nonzero coefficients on selected SD bases are indicated relative to the position of the nonzero coefficients on the selected FD bases and DD bases. One parameter is used to indicate the number of nonzero coefficients on the selected SD bases.

Embodiments described herein in the context of Case 2 involve a parameter for providing pairs of SD basis and FD basis and a parameter for providing DD basis. Generally, in some embodiments, Case 2 includes Step 1 and Step 2.

At Step 1 of Case 2, bases are selected. Bitmaps or combinatorial coefficients are used to indicate the selected pairs of SD-FD bases from SD and FD base sets. The number P of SD-FD pairs is configured by higher layer signaling (e.g., 2N₁N₂*N₃ bits to indicate P number of SD-FD pairs in a bitmap).

Other bitmaps or sets of combinatorial coefficients are used to indicate the selected DD bases from a DD base set. The K number of selected DD bases is configured by higher layer signaling (e.g., N_{T}, K).

At Step 2 of Case 2, nonzero coefficients on the selected bases and basis pairs are indicated. The nonzero coefficients on selected pairs of SD-FD basis and selected DD bases are indicated in one bitmap or combinatorial coefficients. For example, in some embodiments, one bitmap or combinatorial coefficients are used to indicate the position of nonzero coefficients on selected pairs of SD-FD basis and DD bases, and one parameter is used to indicate the number of nonzero coefficients. For example, the bitmap length is P*K.

Embodiments described herein in the context of Case 3 involve a parameter for providing pairs of FD basis and DD basis and a parameter for providing SD basis. Generally, in some embodiments, Case 3 includes Step 1 and Step 2.

At Step 1 of Case 3, bases are selected. Bitmaps or combinatorial coefficients are used to indicate the selected pairs of FD-D bases from FD and DD base sets. The number P of FD-DD pairs is configured by higher layer signaling (N₃*N_{T}, P).

Other bitmaps or sets of combinatorial coefficients are used to indicate the selected SD bases from a SD base set. The N number of selected SD bases is configured by higher layer signaling (e.g., 2N₁N₂, N).

At Step 2 of Case 2, nonzero coefficients on the selected bases and basis pairs are indicated. The nonzero coefficients on selected pairs of FD-DD basis and selected SD bases are indicated in one bitmap or combinatorial coefficients. For example, in some embodiments, one bitmap or combinatorial coefficients are used to indicate the position of nonzero coefficients on selected pairs of FD-DD basis and SD bases, and one parameter is used to indicate the number of nonzero coefficients. For example, the bitmap length is P*N.

Embodiments described herein in the context of Case 4 involve a parameter for providing pairs of SD basis and DD basis and a parameter for providing FD basis. Generally, in some embodiments, Case 4 includes Step 1 and Step 2.

At Step 1 of Case 4, bases are selected. Bitmaps or combinatorial coefficients are used to indicate the selected pairs of SD-DD bases from SD and DD base sets. The number P of SD-DD pairs is configured by higher layer signaling (e.g., 2N₁N₂*N_{T} bits to indicate P number of SD-DD pairs in a bitmap).

Other bitmaps or sets of combinatorial coefficients are used to indicate the selected FD bases from a FD base set. The M number of selected FD bases is configured by higher layer signaling (e.g., N₃, M).

At Step 2 of Case 4, nonzero coefficients on the selected bases and basis pairs are indicated. The nonzero coefficients on selected pairs of SD-DD basis and selected FD bases are indicated in one bitmap or combinatorial coefficients. For example, in some embodiments, one bitmap or combinatorial coefficients are used to indicate the position of nonzero coefficients on selected pairs of SD-DD basis and FD bases, and one parameter is used to indicate the number of nonzero coefficients. For example, the bitmap length is P*M.

As discussed, embodiments herein relate to pairing of SD and FD bases, FD and DD bases, or SD and DD bases. In some examples, embodiments are applied to a Case 5, in which a parameter is used for providing a triplet of SD-basis, FD-basis, and DD-basis. Generally, in some embodiments, Case 5 includes Step 1 and Step 2.

At Step 1 of Case 5, bases are selected. A bitmap or combinatorial coefficients are used to indicate the selected triplets of SD-FD-DD bases from SD, FD, and DD base sets. The number P of SD-FD-DD triplets is configured by higher layer signaling (e.g., 2N₁N₂*N₃*N_{T}, P).

At Step 2 of Case 5, no bitmaps or combinatorial coefficients are used to indicate the position of nonzero coefficients on triplets of SD-FD-DD bases.

### VI. Example Operations and Implementations

As described herein, example embodiments exploit time-domain correlation/Doppler-domain information to assist precoding for alleviating performance loss and reducing CSI overhead. Accordingly, embodiments described herein address technical problems related to rapid aging of the reported CSI, for example, as a UE travels at a high/medium speed. Embodiments described herein include refinements to the 3GPP Rel-16/17 Type-II codebook. In some embodiments, reference FD basis and reference DD basis are used to further alleviate performance loss and to further reduce CSI overhead.

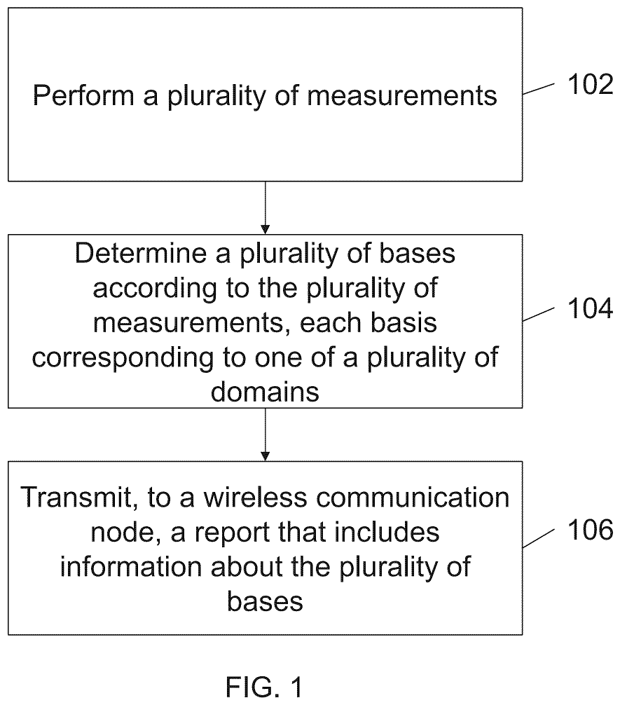

FIG. 1 shows an exemplary flowchart for a method for wireless communication. In particular, the method includes example operations for implementing example embodiments described herein in order to alleviate performance loss related to CSI measurement and reporting. In some embodiments, the method illustrated in FIG. 1 is implemented by a terminal, such as a UE.

Operation 102 includes performing a plurality of measurements relating to a channel status. In some embodiments, the measurements are performed in response to receiving a reference signal. For example, the reference signal is a channel state information reference signal (CSI-RS). In some embodiments, the measurements are performed to derive channel state information (CSI), or channel measurement information of a channel.

In some embodiments, each of the plurality of measurements corresponds to a different measurement time occasion of a CSI-RS resource of the reference signal. In some embodiments, each of the plurality of measurements corresponds to a measurement time occasion of a different CSI-RS resource of the reference signal.

Operation 104 includes determining a plurality of bases according to the plurality of measurements. Each basis corresponds to one of a plurality of domains. In some embodiments, the plurality of domains includes a spatial domain (SD), a frequency domain (FD), and a Doppler domain (DD), and each basis belongs to one of the plurality of domains. Thus, in some examples, the plurality of bases may include one or more SD bases, one or more FD bases, and/or one or more DD bases. In some embodiments, the plurality of bases are determined or selected from base sets in the SD, the FD, and the DD. For example, the plurality of bases is a selected subset of a set of bases.

In some embodiments, operation 104 includes selecting the plurality of bases from respective base sets for the plurality of domains. In some embodiments, the number of the plurality of bases that is selected in each of the plurality of domains is indicated in a RRC signaling.

In some embodiments, operation 104 is performed in response to a higher-layer parameter of a RRC signaling having a particular value. For example, the plurality of bases are determined in response to a TimedomaincorrelationMode parameter having the value of 1.

In some embodiments, each of the plurality of bases is a discrete Fourier transform (DFT) basis.

Operation 106 includes transmitting, to a wireless communication node, a report that includes information about the plurality of bases. In some embodiments, the report relates to a channel status. In some embodiments, the information is configured to identify the plurality of bases. For example, as described above, the plurality of bases are selected from SD, FD, and DD base sets, and the information included in the report identifies the selected plurality of bases. In some embodiments, the information is configured to both identify the plurality of bases and to indicate nonzero coefficients on the plurality of bases that represent the plurality of measurements.

In some embodiments, the information about the plurality of bases includes a plurality of information portions that are each associated with a domain of the plurality of domains. For example, given SD, FD, and DD, the information about the plurality of bases includes a first information portion corresponding to the SD, a second information portion corresponding to the FD, and a third information portion corresponding to the DD. Accordingly, in some embodiments, the number of information portions is equal to a number of the plurality of domains. In some embodiments, each information portion identifies, from a base set for the corresponding domain, each basis of the plurality of bases that corresponds to the corresponding domain In the above non-limiting illustrative example, the first information portion corresponding to the SD identifies certain bases of the determined plurality of basis with respect to a given base set for the SD, with each of the certain bases corresponding to the SD.

In some embodiments, the information about the plurality of bases includes a plurality of information portions that are each associated with one or more corresponding domains of the plurality of domains. For example, a pair or triplet of domains within the plurality of domains is defined, and a given information portion is associated with the pair or triplet of domains (rather than only being associated with one domain of the plurality of domains). Accordingly, in some embodiments, the number of information portions is less than the number of domains. In some embodiments, each information portion identifies, from respective base sets for the one or more corresponding domains, each basis of the plurality of bases that corresponds to the one or more corresponding domains.

In some embodiments, the information included in the report is configured to indicate the plurality of bases relative to a particular basis that is selected as a reference basis. For example, the reference basis is a basis of the plurality of bases that is a discrete Fourier transform basis vector numbered zero.

In some embodiments, the information included in the report includes one or more bitmaps each including a plurality of bits that each correspond to two or more bases of the plurality of bases, and the two or more bases correspond to different domains. In some embodiments, a zero bit of the one or more bitmaps identifies weighted coefficients corresponding to each of the two or more bases that is not included in the report. For example, a zero bit of a bitmap indicates that the two or more bases corresponding to the zero bit are not included in the determined or selected plurality of bases. In some embodiments, a total number of nonzero bits across the one or more bitmaps is less than or equal to a threshold that is based on a higher-layer parameter. In some embodiments, a number of nonzero bits in a bitmap of the one or more bitmaps is less than or equal to a threshold that is based on a higher-layer parameter.

In some embodiments, the information includes a bitmap for a SD of the plurality of domains (or a pair of domains that includes the SD), and the bitmap occupies a number of bits that is based on a number of CSI-RS antenna ports in a horizontal dimension and a number of CSI-RS antenna ports in a vertical dimension.

In some embodiments, the information includes a bitmap for a FD of the plurality of domains (or a pair of domains that includes the FD), and the bitmap occupies a number of bits that is based on a total number of frequency domain precoding matrices and a number of subbands. In some embodiments, the total number of FD precoding matrices is indicated in a higher layer parameter numberofPMI-SubbandsPerCQI-Subband.

In some embodiments, the information includes a bitmap for a DD of the plurality of domains (or a pair of domains that includes the DD), and the bitmap occupies a number of bits that is based on a number of DD precoding matrices. The number of DD precoding matrices is controlled by a CSI measurement window. In some embodiments, the CSI measurement window includes the different measurement time intervals corresponding to the plurality of measurements.

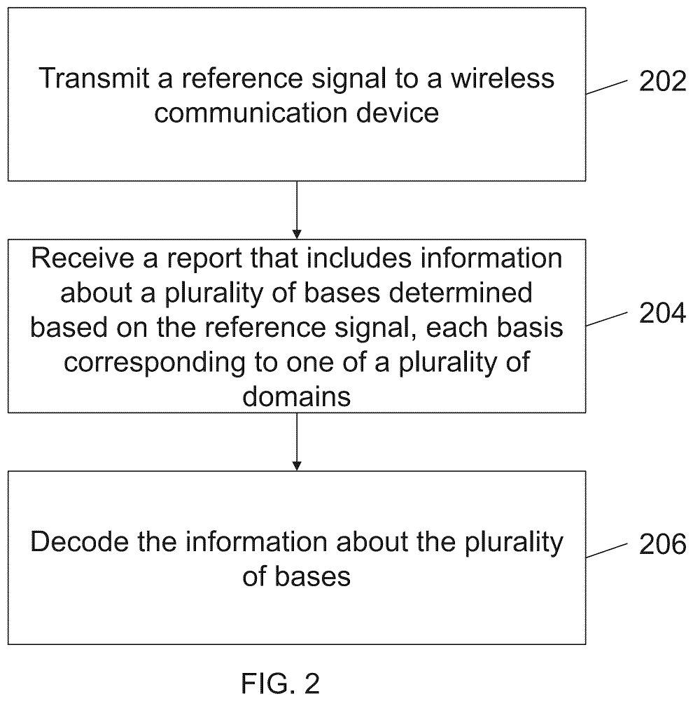

FIG. 2 shows an exemplary flowchart for another method for wireless communication. The method includes example operations for implementing example embodiments described herein for efficient CSI reporting.

Operation 202 includes transmitting a reference signal to a wireless communication device. In some embodiments, the reference signal includes a CSI-RS that is transmitted to the wireless communication device via a radio channel. In some embodiments, the reference signal enables the wireless communication device to perform measurements related to a channel status of the channel via which the reference signal is transmitted.

Operation 204 includes receiving a report that includes information about a plurality of bases that are determined based on the reference signal. Each basis corresponds to one of a plurality of domains.

Operation 206 includes decoding the information about the plurality of bases. In some embodiments, the information is decoded to obtain a second information about the plurality of measurements performed by the wireless communication device relating to a channel status.

In some embodiments, each of the plurality of measurements corresponds to a different measurement time occasion of a reference signal resource of the reference signal. In some embodiments, each of the plurality of measurements corresponds to a measurement time occasion of a different reference signal resource of the reference signal.

In some embodiments, the method further includes determining, for each of the plurality of domains, a parameter that indicates a number of bases to be included in the report. The method further includes transmitting, to the wireless communication device, a RRC signaling that includes the parameter for each of the plurality of domains. In some embodiments, the RRC signaling includes a TimedomaincorrelationMode parameter.

In some embodiments, the information about the plurality of bases includes a plurality of information portions that are each associated with a domain of the plurality of domains. For example, given SD, FD, and DD, the information about the plurality of bases includes a first information portion corresponding to the SD, a second information portion corresponding to the FD, and a third information portion corresponding to the DD. Accordingly, in some embodiments, the number of information portions is equal to a number of the plurality of domains. In some embodiments, each information portion identifies, from a base set for the corresponding domain, each basis of the plurality of bases that corresponds to the corresponding domain In the above non-limiting illustrative example, the first information portion corresponding to the SD identifies certain bases of the determined plurality of basis with respect to a given base set for the SD, with each of the certain bases corresponding to the SD. Thus, in some embodiments, the information is decoded based on the plurality of information portions.

In some embodiments, the information about the plurality of bases includes a plurality of information portions that are each associated with one or more corresponding domains of the plurality of domains. For example, a given information portion is associated with a pair or triplet of domains defined within the plurality of domains (rather than only being associated with one domain of the plurality of domains). Accordingly, in some embodiments, the number of information portions is less than the number of domains. In some embodiments, each information portion identifies, from respective base sets for the one or more corresponding domains, each basis of the plurality of bases that corresponds to the one or more corresponding domains. Thus, in some embodiments, the information is decoded based on the plurality of information portions.

In some embodiments, the information included in the report is configured to indicate the plurality of bases relative to a particular basis that is selected as a reference basis. For example, the reference basis is a basis of the plurality of bases that is a discrete Fourier transform basis vector numbered zero. Thus, in some embodiments, the information is decoded based on one of the bases being a reference basis.

In some embodiments, the information included in the report includes one or more bitmaps each including a plurality of bits that each correspond to two or more bases of the plurality of bases, and the two or more bases correspond to different domains. Thus, decoding the information includes decoding each of the one or more bitmaps. In some embodiments, the information is decoded based on a zero bit of the one or more bitmaps identifying weighted coefficients corresponding to each of the two or more bases that is not included in the report. For example, a bitmap is decoded based on a zero bit of the bitmap indicating that the two or more bases corresponding to the zero bit are not included in the determined or selected plurality of bases.

In some embodiments, a total number of nonzero bits across the one or more bitmaps is less than or equal to a threshold that is based on a higher-layer parameter. In some embodiments, a number of nonzero bits in a bitmap of the one or more bitmaps is less than or equal to a threshold that is based on a higher-layer parameter. Thus, in some embodiments, the method further includes determining the threshold and transmitting the threshold to the wireless communication device in a higher-layer signaling. In some embodiments, the threshold is determined and communicated to the wireless communication device based on parameters that indicate a number of bases or basis pairs for the wireless communication device to select in each domain (or each domain pairing).

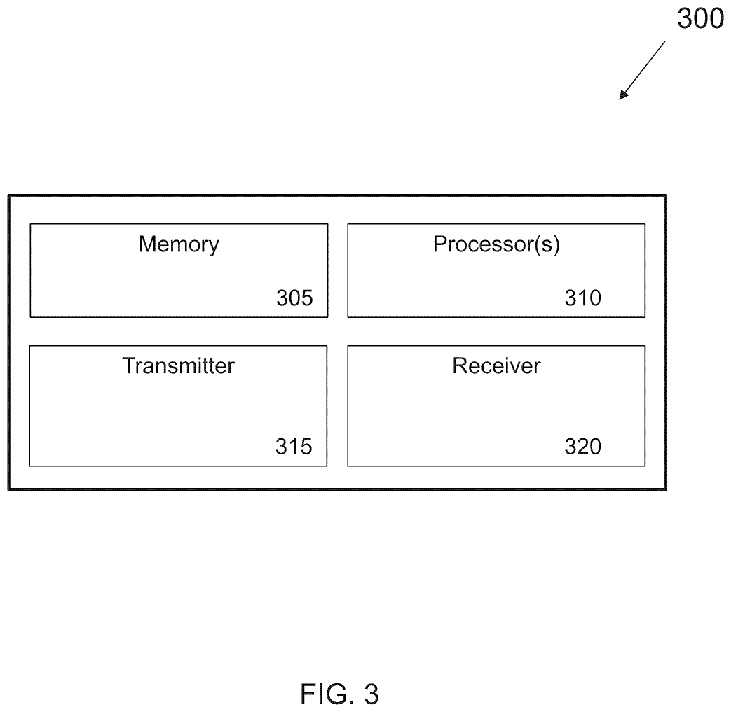

FIG. 3 shows an exemplary block diagram of a hardware platform 300 that may be a part of a network device or a wireless communication node (e.g., base station) or a wireless communication device (e.g., a user equipment (UE), a terminal). The hardware platform 300 includes at least one processor 310 and a memory 305 having instructions stored thereupon. In some embodiments, the memory 305 may be internal to the processor 310. The instructions upon execution by the processor 310 configure the hardware platform 300 to perform the operations described in FIGS. 1 and 2 and in the various embodiments described in this patent document. The transmitter 315 transmits or sends information or data to another device. For example, a network device transmitter can send a message to a user equipment. The receiver 320 receives information or data transmitted or sent by another device. For example, a user equipment can receive a message from a network device.

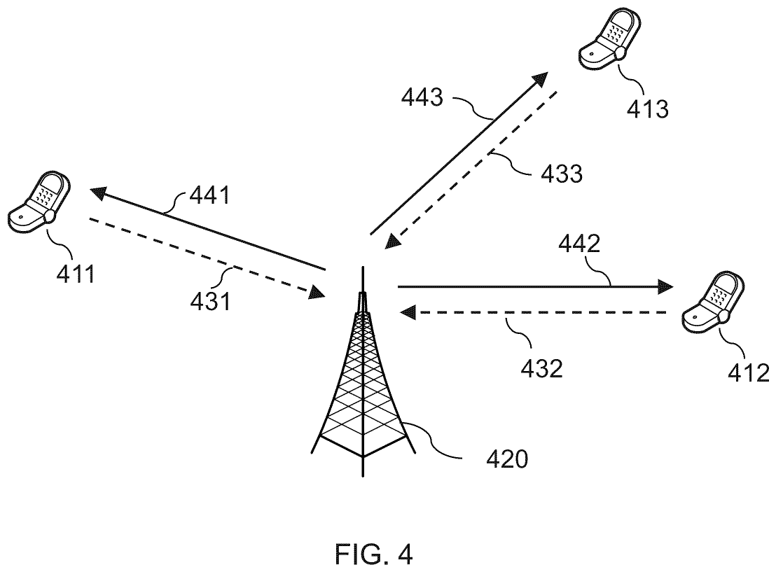

The implementations as discussed above will apply to a wireless communication. FIG. 4 shows an example of a wireless communication system (e.g., a 5G or NR cellular network) that includes a base station 420 and one or more user equipment (UE) 411, 412 and 413. In some embodiments, the UEs access the BS (e.g., the network) using a communication link to the network (sometimes called uplink direction, as depicted by dashed arrows 431, 432, 433), which then enables subsequent communication (e.g., shown in the direction from the network to the UEs, sometimes called downlink direction, shown by arrows 441, 442, 443) from the BS to the UEs. In some embodiments, the BS send information to the UEs (sometimes called downlink direction, as depicted by arrows 441, 442, 443), which then enables subsequent communication (e.g., shown in the direction from the UEs to the BS, sometimes called uplink direction, shown by dashed arrows 431, 432, 433) from the UEs to the BS. The UE may be, for example, a smartphone, a tablet, a mobile computer, a machine to machine (M2M) device, an Internet of Things (IoT) device, and so on.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements and variations can be made based on what is described and illustrated in this disclosure.

What is claimed is:

1. A method for wireless communication, comprising:
performing, by a wireless communication device, a plurality of channel state measurements;
determining, by the wireless communication device, a plurality of discrete Fourier transform (DFT) bases according to the plurality of channel state measurements, wherein each basis corresponds to one of a plurality of domains; and
transmitting, by the wireless communication device to a wireless communication node, a report that includes information about the plurality of DFT bases.

2. The method of claim 1, wherein the information included in the report is configured to indicate the plurality of DFT bases relative to a particular DFT basis that is selected as a reference basis.

3. The method of claim 1, wherein the information included in the report includes one or more bitmaps each including a plurality of bits that each correspond to two or more bases of the plurality of DFT bases, and wherein the two or more bases correspond to different domains.

4. The method of claim 3, wherein a zero bit of the one or more bitmaps identifies weighted coefficients corresponding to each of the two or more bases that is not included in the report.

5. The method of claim 3, wherein a total number of nonzero bits across the one or more bitmaps is less than or equal to a threshold that is based on a higher-layer parameter.

6. The method of claim 3, wherein a number of nonzero bits in a bitmap of the one or more bitmaps is less than or equal to a threshold that is based on a higher-layer parameter.

7. The method of claim 1, wherein the wireless communication device determines the plurality of DFT bases in response to a higher-layer parameter of a radio resource control (RRC) signaling received by the wireless communication device having a particular value.

8. The method of claim 1, wherein each of the plurality of measurements corresponds to a different measurement time occasion of a channel state information reference signal (CSI-RS) resource.

9. The method of claim 1, wherein each of the plurality of measurements corresponds to a measurement time occasion of a different CSI-RS resource.

10. The method of claim 1, further comprising:
selecting, by the wireless communication device, the plurality of DFT bases from respective base sets for the plurality of domains.

11. The method of claim 10, wherein a number of the plurality of DFT bases that is selected in each of the plurality of domains is indicated in a RRC signaling received by the wireless communication device.

12. A method for wireless communication, comprising:
transmitting, by a wireless communication node to a wireless communication device, a channel state reference signal;
receiving, by the wireless communication node from the wireless communication device, a report that includes information about a plurality of discrete Fourier transform (DFT) bases that are determined based on the reference signal, wherein each DFT basis corresponds to one of a plurality of domains; and
decoding, by the wireless communication node, the information about the plurality of DFT bases.

13. The method of claim 12, further comprising:
determining, for each of the plurality of domains, a parameter that indicates a number of DFT bases to be included in the report; and
transmitting, by the wireless communication node to the wireless communication device, a RRC signaling that includes the parameter for each of the plurality of domains.

14. The method of claim 12, wherein the reference signal includes a channel state information reference signal (CSI-RS) that is transmitted via a radio channel and configured to enable a plurality of measurements relating to a channel status for the radio channel.

15. The method of claim 14, further comprising:
obtaining a second information about the plurality of measurements based on the decoding of the information about the plurality of DFT bases, wherein the plurality of measurements are performed by the wireless communication device.

16. The method of claim 14, wherein each of the plurality of measurements corresponds to a different measurement time occasion of a reference signal resource of the reference signal.

17. The method of claim 14, wherein each of the plurality of measurements corresponds to a measurement time occasion of a different reference signal resource of the reference signal.

18. The method of claim 12, wherein the information included in the report is configured to indicate the plurality of bases relative to a particular basis that is selected as a reference basis, wherein the reference basis is a DFT vector numbered zero in a corresponding domain.

19. An apparatus for wireless communication, comprising a memory and a processor, wherein the processor executes instructions stored on the memory to implement a method comprising:
performing a plurality of channel state measurements at a wireless communication device;
determining a plurality of discrete Fourier transform (DFT) bases according to the plurality of channel state measurements, wherein each basis corresponds to one of a plurality of domains; and
transmitting, from the wireless communication device to a wireless communication node, a report that includes information about the plurality of DFT bases.

20. An apparatus for wireless communication, comprising a memory and a processor, wherein the processor executes instructions stored on the memory to implement a method comprising:
transmitting, by a wireless communication node to a wireless communication device, a channel state reference signal;
receiving, by the wireless communication node from the wireless communication device, a report that includes information about a plurality of discrete Fourier transform (DFT) bases that are determined based on the reference signal, wherein each DFT basis corresponds to one of a plurality of domains; and
decoding, by the wireless communication node, the information about the plurality of DFT bases.
